(19) United States
(12) Patent Application Publication
(10) Pub. No.: US 2009/0313217 A1
(43) Pub. Date: Dec. 17, 2009

(54) SYSTEMS AND METHODS FOR CLASSIFYING SEARCH QUERIES

(75) Inventors: Alessio Signorini, Pisa (IT); Alessandro Arzilli, Pisa (IT); Nitin Mangesh Shetti, Woodbridge, NJ (US); Abhishek Mehrota, New Brunswick, NJ (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: IAC Search & Media, Inc., Oakland, CA (US)

(21) Appl. No.: 12/138,317

(22) Filed: Jun. 12, 2008

(51) Int. Cl. G06F 7/06; G06F 17/30

(52) U.S. Cl. 707/3; 707/E17.014; 707/E17.046

(57) ABSTRACT

Systems and methods for approximating a query classification are disclosed. The systems and methods may include an input interface that receives a textual input, an extractor that extracts at least one concept from the textual input, a database having a plurality of concepts stored therein, each concept associated with at least one classification, a classifier that associates the at least one concept with at least one category, a computational unit that determines a category of the textual input based on the at least one classification of the at least one concept from the database and the at least one category of the at least one concept from the classifier, and an output interface to store and transmit the category of the at least one concept in response to the textual input.

### FIELD

This invention relates to the field of search engines and, in particular, to systems and methods for classifying search queries.

### BACKGROUND

The Internet is a global network of computer systems and websites. These computer systems include a variety of documents, files, databases, and the like, which include information covering a variety of topics. It can be difficult for users of the Internet to locate information on the Internet. Search engines are often used by people to locate information on the Internet.

A user accesses a user interface of a search engine, which typically includes a search box for entering a search query. The user enters their search query in the search box and selects a search button to transmit a search request to the search engine. The search engine compares the text with data in a database or data source and extracts information based on the text. The information includes uniform resource locators (URLs) or other answers pertaining to the search query. This information is then transmitted from the search engine to the user for display at the user's computer.

### SUMMARY

Embodiments of the invention relate to a computer-implemented method that includes receiving a textual input; extracting at least one concept from the textual input; determining at least one category associated with the at least one concept; identifying a set of pre-classified text based on the at least one concept; determining a set of categories corresponding to the textual input based on the at least one category and the set of pre-classified text; and storing the set of categories corresponding to the textual input.

The method may also include determining an answer to the textual input based on the set of categories.

The textual input may include a textual search query.

The textual input may include textual information from a web page.

The textual input may include textual information associated with an image.

The concept may include a name.

The concept may include a word.

The concept may include a N-gram.

Identifying a set of pre-classified text based on the at least one concept may include identifying a relative importance of each pre-classified text in the set of pre-classified text.

Identifying the relative importance of each pre-classified text in the set of pre-classified text may include assigning a score to each pre-classified text.

Determining at least one category associated with the at least one concept may include determining a set of categories associated with the at least one concept.

Determining a set of categories to assign the input based on the at least one category and the set of pre-classified text may include assigning a score to each category of the set of categories.

Determining the answer may include determining a set of URLs and providing the set of URLs to a user.

Determining the answer may include determining a set of URLs, and wherein determining the set of URLs comprises identifying URLs from each category from the set of categories.

Determining the answer may include determining an advertisement to provide to a user.

Determining the answer may include determining a set of search queries and transmitting the set of search queries to a user.

The method may also include receiving a selection of a search query from the set of search queries and transmitting a set of URLs associated with the selection to the user.

Determining the answer may include identifying one or more of an image, video, blog, news information, news image, web page, sound, podcast, digital object or multimedia object.

The method may also include displaying the set of URLs on a client computer, the set of URLs organized according to each category in the set of categories.

Determining the answer may include identifying a web page as a spam page.

Determining the answer may include identifying a web page as having adult content.

Extracting at least one concept from the textual input may include extracting a plurality of concepts from the textual input.

The method may also include determining at least one category associated with the at least one concept comprises determining at least one category associated with each concept of the plurality of concepts; and identifying a set of pre-classified text based on the at least one concept comprises identifying a set of pre-classified text based on each concept of the plurality of concepts.

Embodiments of the invention also relate to a computer system including an input interface to receive a textual input; an extractor to extract at least one concept from the textual input; a database having a plurality of concepts stored therein, each concept associated with at least one classification; a classifier to associate the at least one concept with at least one category; a computational unit to determine a category of the textual input based on the at least one classification of the at least one concept from the database and the at least one category of the at least one concept from the classifier; and an output interface to transmit the category of the at least one concept in response to the textual input.

Embodiments of the invention also relate to a computer-readable storage medium having stored thereon a set of instructions which, when executed by a processor of a computer, executes a method including receiving a textual input; extracting at least one concept from the textual input; determining at least one category associated with the at least one concept; identifying a set of pre-classified text based on the at least one concept; determining a set of categories corresponding to the textual input based on the at least one category and the set of pre-classified text; and storing the set of categories corresponding to the textual input.

### BRIEF DESCRIPTION OF THE DRAWINGS

The invention is described by way of example with reference to the accompanying drawings, wherein:

FIG. 1 is a block diagram illustrating a system for searching in accordance with one embodiment of the invention;

FIG. 2 is a block diagram of an exemplary computer system;

FIG. 3 is a block diagram of an input approximation classification system in accordance with one embodiment of the invention;

FIG. 4 is a flow diagram of a method of input approximation classification in accordance with one embodiment of the invention;

FIG. 5 is a schematic drawing of a user interface for entering a search query in accordance with one embodiment of the invention;

FIGS. 6A and 6B are schematic drawings of a user interface for providing search results in response to a search query in accordance with one embodiment of the invention;

FIG. 7 is a block diagram of an input classification system in accordance with one embodiment of the invention;

FIG. 8 is a block diagram of an input classification system in accordance with one embodiment of the invention; and

FIG. 9 is a flow diagram of a method of input classification in accordance with one embodiment of the invention.

### DETAILED DESCRIPTION

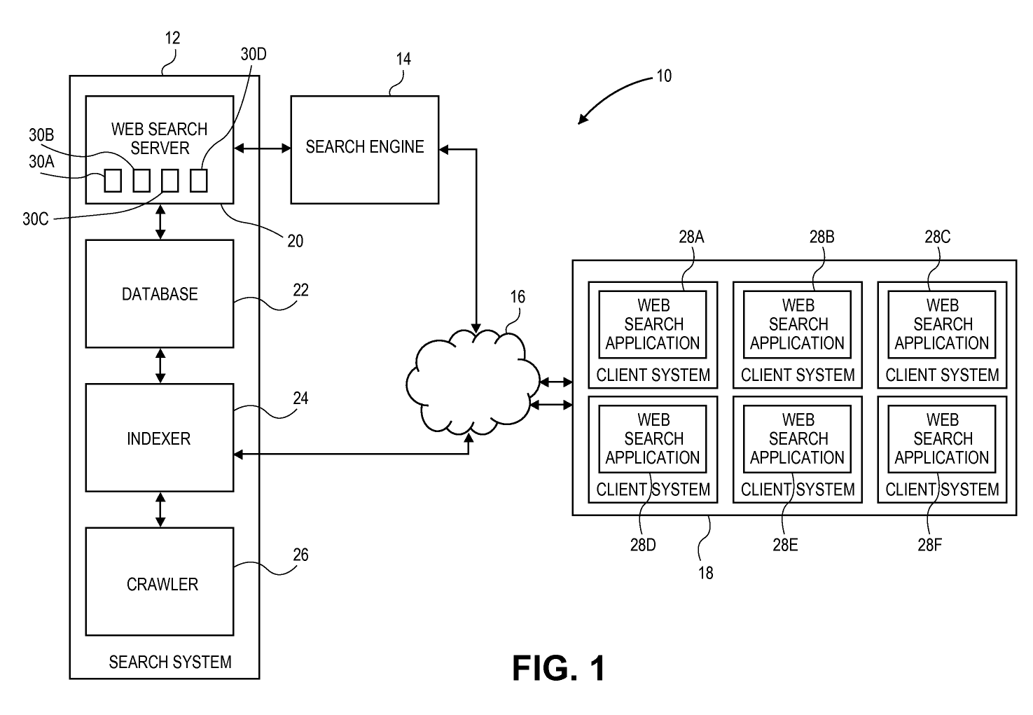

FIG. 1 of the accompanying drawings shows a network system 10 which can be used in accordance with one embodiment of the present invention. The network system 10 includes a search system 12, a search engine 14, a network 16 in the form of the Internet, a wide area protocol (WAP), etc., and a plurality of client systems 18. The search system 12 includes a server 20, a database 22, an indexer 24, and a crawler 26. The plurality of client systems 18 includes a plurality of web search applications 28a-f, located on each of the plurality of client systems 18. The server 20 includes a plurality of databases 30a-d. The plurality of provider systems 32 includes a plurality of web sites, located on each of the provider systems 32.

The search system 12 is connected to the search engine 14. The search engine 14 is connected to the plurality of client systems 18 and provider systems 32 via the network 16. The server 20 is in communication with the database 22 which is in communication with the indexer 24. The indexer 24 is in communication with the crawler 26. The crawler 26 is capable of communicating with the plurality of target client systems 18 via the network 16.

The web search server 20 is typically a computer system, and may be an HTTP (Hypertext Transfer Protocol) server. It is envisioned that the search engine 14 may be located at the web search server 20. The web search server 20 typically includes at least processing logic and memory.

The indexer 24 is typically a software program which is used to create an index, which is then stored in storage media. The index is typically a table of alphanumeric terms with a corresponding list of the related documents or the location of the related documents (e.g., a pointer). An exemplary pointer is a Uniform Resource Locator (URL). The indexer 24 may build a hash table, in which a numerical value is attached to each of the terms. The database 22 is stored in a storage media, which typically includes the documents which are indexed by the indexer 24. The index may be included in the same storage media as the database 22 or in a different storage media. The storage media may be volatile or non-volatile memory that includes, for example, read only memory (ROM), random access memory (RAM), magnetic disk storage media, optical storage media, flash memory devices and zip drives.

The crawler 26 is a software program or software robot, which is typically used to build lists of the information found on Web sites. Another common term for the crawler 26 is a spider. The crawler 26 typically searches Web sites on the Internet and keeps track of the information located in its search and the location of the information.

The network 16 (16a, 16b, 16c, collectively) is a local area network (LAN), wide area network (WAN), a telephone network, such as the Public Switched Telephone Network (PSTN), an intranet, the Internet, or combinations thereof.

The plurality of client systems 18 may be mainframes, minicomputers, personal computers, laptops, personal digital assistants (PDA), cell phones, and the like. The plurality of client systems 18 are characterized in that they are capable of being connected to the network 16. The web search application 28a-f is typically an Internet browser or other software. Web sites may be located on the client systems 18.

The databases 30a-d are stored in storage media located at the server 20, which include structured data, as will be discussed hereinafter. The storage media may be volatile or non-volatile memory that includes, for example, read only memory (ROM), random access memory (RAM), magnetic disk storage media, optical storage media, flash memory devices and zip drives.

In use, the crawler 26 crawls websites, such as the websites of the plurality of provider systems 32, to locate information on the web. The crawler 26 employs software robots to build lists of the information. The crawler 26 may include one or more crawlers to search the web. The crawler 26 typically extracts the information and stores it in the database 22. The indexer 24 creates an index of the information stored in the database 22. Alternatively, if a database 22 is not used, the indexer 24 creates an index of the information and where the information is located in the Internet (typically a URL).

When a user of one of the plurality of client systems 18 enters a search on the web search application 28, the search is communicated to the search engine 14 over the network 16. For example, a signal is transmitted from one of the client systems 18, the signal having a destination address (e.g., address representing search engine), a request (e.g., search query) and a return address (e.g., address representing client system). The search engine 14 communicates the search to the server 20 at the search system 12. The search engine 14 may analyze the query before sending it to the server 20. For example, the search engine 14 may parse and extract search terms from the query. The server 20 accesses the database 22 to provide a search result, which is communicated to the user via the search engine 14 and network 16. For example, the server 20 may extract search results and transmit the search results by transmitting a signal from the search engine 14 to the client system 18. For example, the signal may include a destination address corresponding to the return address of the client system, and a web results page that includes the search results.

Alternatively or in addition to accessing the index and/or database to provide the search result, the databases 30a-d can be searched, as will be described hereinafter.

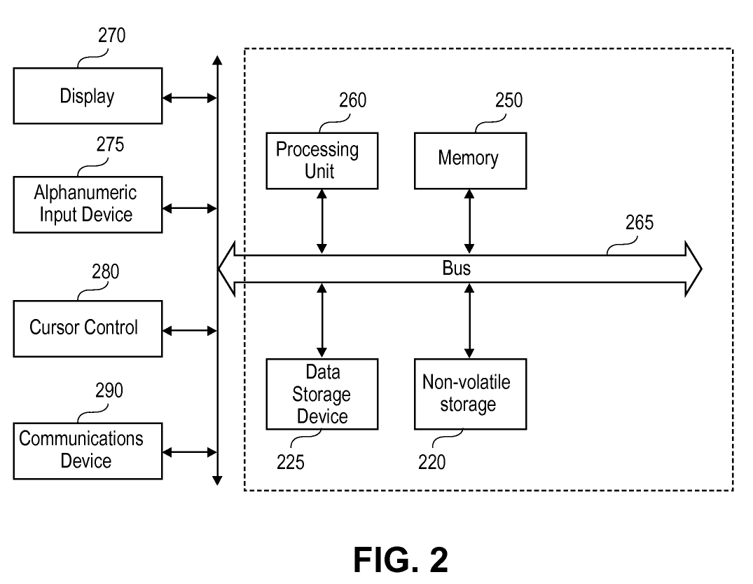

FIG. 2 is one embodiment of a computer system on which embodiments of the present invention may be implemented. It will be apparent to those of ordinary skill in the art, however, that other alternative systems of various system architectures may also be used.

The data processing system illustrated in FIG. 2 includes a bus or other internal communication means 265 for communicating information, and a processor 260 coupled to the bus 265 for processing information. The system further comprises a random access memory (RAM) or other volatile storage device 250 (referred to as memory), coupled to bus 265 for storing information and instructions to be executed by processor 260. Main memory 250 also may be used for storing temporary variables or other intermediate information during execution of instructions by processor 260. The system also comprises a read only memory (ROM) and/or static storage device 220 coupled to bus 265 for storing static information and instructions for processor 260, and a data storage device 225 such as a magnetic disk or optical disk and its corresponding disk drive. Data storage device 225 is coupled to bus 265 for storing information and instructions.

The system may further be coupled to a display device 270, such as a cathode ray tube (CRT) or a liquid crystal display (LCD) coupled to bus 265 through bus 265 for displaying information to a computer user. An alphanumeric input device 275, including alphanumeric and other keys, may also be coupled to bus 265 through bus 265 for communicating information and command selections to processor 260. An additional user input device is cursor control device 280, such as a mouse, a trackball, stylus, or cursor direction keys coupled to bus 265 through bus 265 for communicating direction information and command selections to processor 260, and for controlling cursor movement on display device 270.

Another device, which may optionally be coupled to computer system 200, is a communication device 290 for accessing other nodes of a distributed system via a network. The communication device 290 may include any of a number of commercially available networking peripheral devices such as those used for coupling to an Ethernet, token ring, Internet, or wide area network. The communication device 290 may further be a null-modem connection, or any other mechanism that provides connectivity between the computer system 200 and the outside world. Note that any or all of the components of this system illustrated in FIG. 2 and associated hardware may be used in various embodiments of the present invention.

It will be appreciated by those of ordinary skill in the art that any configuration of the system may be used for various purposes according to the particular implementation. The control logic or software implementing the present invention can be stored in main memory 250, mass storage device 225, or other storage medium locally or remotely accessible to processor 260.

It will be apparent to those of ordinary skill in the art that the system, method, and process described herein can be implemented as software stored in main memory 250 or read only memory 220 and executed by processor 260. This control logic or software may also be resident on an article of manufacture comprising a computer readable medium having computer readable program code embodied therein and being readable by the mass storage device 225 and for causing the processor 260 to operate in accordance with the methods and teachings herein.

The present invention may also be embodied in a handheld or portable device containing a subset of the computer hardware components described above. For example, the handheld device may be configured to contain only the bus 265, the processor 260, and memory 250 and/or 225. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 260, a data storage device 225, a bus 265, and memory 250, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

It will be appreciated by those of ordinary skill in the art that any configuration of the system may be used for various purposes according to the particular implementation. The control logic or software implementing the present invention can be stored on any machine-readable medium locally or remotely accessible to processor 260. A machine-readable medium includes any mechanism for storing or transmitting information in a form readable by a machine (e.g. a computer). For example, a machine readable medium includes read-only memory (ROM), random access memory (RAM), magnetic disk storage media, optical storage media, flash memory devices, electrical, optical, acoustical or other forms of propagated signals (e.g. infrared signals, digital signals, etc.).

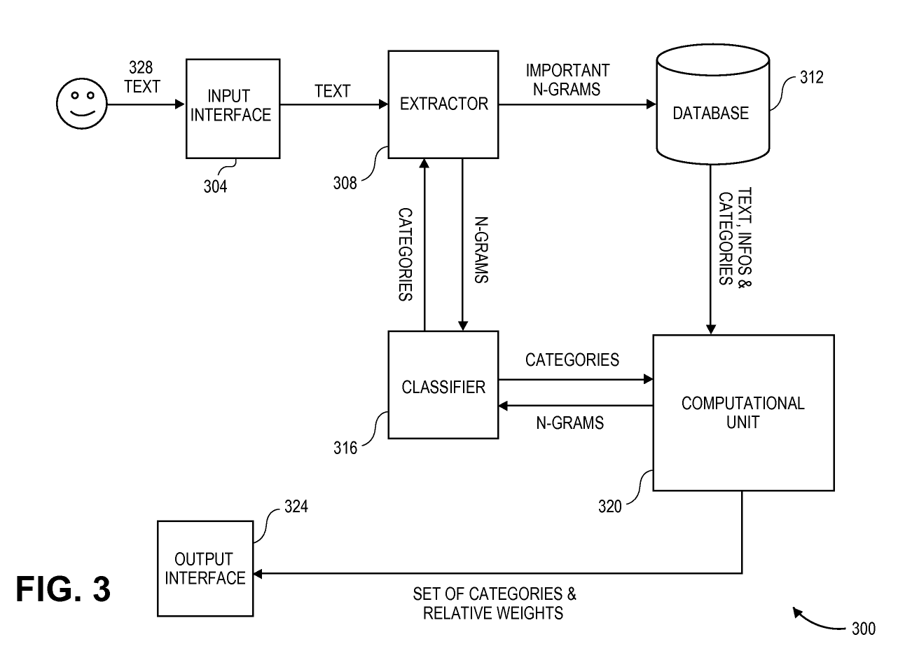

FIG. 3 is a block diagram of an input approximation classification system 300. The input approximation classification system 300 may be located in the search engine 14 or in the server 20 or may be provided in a separate computer system or server connected to the search engine 14 and/or server 20 of the search system 12. The input approximation classification system 300 may be used to classify all input or only input that has not been previously classified.

The input approximation classification system 300 includes an input interface 304, an extractor 308, a database 312, a classifier 316, a computational unit 320 and an output interface 324. The input interface 304 is coupled with the extractor 308. The extractor 308 is coupled with the database 312 and the classifier 316. The database 312 and the classifier 316 are coupled with the computational unit 320. The computational unit 320 is coupled with the output interface 324.

The input interface 304 is configured to receive a textual input 328. The textual input 328 may be, for example, a search query, a snippet of a web page, a description of an image, a blog post, a news article, an image, a sound, a video, a podcast, any digital image or multimedia object, and the like. The input interface 304 communicates the textual input 328 to the extractor 308.

The extractor 308 receives the textual input 328 from the input interface 304. The extractor 308 is configured to determine one or more concepts associated with the textual input 328. The one or more concepts are, for example, single words, names, big-grams, tri-grams . . . N-grams, and the like. For example, for a search query of “diabetes side-effects in ten year olds,” the extractor 308 may identify the following N-grams: diabetes, side-ffects, ten, diabetes side-effects, ten year olds, side-effects ten, diabetes ten, diabetes side-effects ten year olds, etc. The extractor 308 may communicate with the classifier 316 to determine the one or more concepts associated with the textual input 328. For example, when the extractor 308 communicates with the classifier 316, the extractor 308 may identify that diabetes, diabetes-side effects and diabetes side-effects ten year olds are the most important concepts associated with the query. The extractor 308 may communicate all possible concepts associated with the textual input 328 to the classifier 316; however, the extractor 308 may only communicate the relevant concepts (those identified by the extractor 308 together with the classifier 316) to the database 312. Alternatively, the extractor 308 may communicate all concepts to the database 312.

The database 312 receives the concepts from the extractor 308. The database 328 includes text, such as the text of a previously submitted query, and a corresponding classification of the text. The database 312 is searched to determine whether any of the previously submitted queries or other text stored in the database 312 matches the concepts received from the extractor 308. The database 328 sends the text and associated category or categories to the computational unit 320.

In one embodiment, the database 328 includes several types of textual information, each type of textual information having one or more corresponding classifications. For example, the textual information may be search queries, textual information associated with an image (e.g., metadata), a web page, and the like. The database 328 may also include a score representing the relative importance of each classification for each text stored in the database. The text in the database 328 is, thus, pre-classified. For example, if a previously submitted query is “Madonna,” the classification of “music artist” is stored with the “Madonna” query. The query may also be stored with the “religion” classification. If both queries are stored, they may be assigned a score. For example, most of the previously submitted queries for Madonna were searches for the music artist, so the score assigned to the music artist classification of Madonna is 95%, while the score assigned the religious classification of Madonna is 5%.

In one embodiment, the classifications are manually determined. For example, a search engine editor identifies the classification of previously submitted queries or web pages. In one embodiment, the classifications are automatically determined. For example, when a search query is identified in a category using the input approximation classification system 300, the classification may be added to the database 312. It will be appreciated that classifications may be stored in the database 312 using a combination of manual and automatic approaches.

The classifications in the database 312 may be based at least in part on correlations. Exemplary correlations that may be made and stored in the database are described in copending U.S. patent application Ser. No. 11/958,322, the entirety of which is hereby incorporated by reference. For example, the correlations may be used to determine previously submitted queries that share the same classification as another query or web page already in the database 312.

In one embodiment, the text in the database is pre-classified according to a query-to-pick (Q2P) correlation. A Q2P correlation associates a query with a pick. When multiple independent users make the same association, the association is a correlation candidate. When the search engine returns a result in response to a query and a user picks that result, the correlation is a query-to-result-pick (Q2RP). In accordance with one embodiment of the invention, the Q2P correlation associates a query with all picks in a user session. This is in contrast to prior art schemes that terminated association of a given query with picks upon issuance of a subsequent query.

With Q2P, all picks recorded during a user session are associated with a given query issued during that user session. For one embodiment, a score is assigned to each association, based upon various factors, including the time between query and pick, the number of intervening queries and/or picks, and the order of queries with respect to picks.

In addition, each association's score can be adjusted based upon well-known factors, including rank of the picks in the result list at the time of association, duration of the pick (interval until next known user action), age or order of association (relative to older or newer associations), and age of the first known issuance of association.

Each user session can be of infinite duration. In a practical application, a reasonable time limit, or limit on intervening actions, should be imposed beyond which no relationship between picks and queries will be assigned. Alternatively or additionally, an interruption of sufficient duration can indicate a break in sessions. A search log excerpt, in accordance with one embodiment of the invention, is shown below as Table 1. In various alternative embodiments, any other items could be captured in the search log, but are excluded here for clarity:

TABLE 1

| Row | Timestamp | User ID | Query | Pick (URL) |
|---|---|---|---|---|
| 101 | 1/1/03 00:00:00 | U1 | Q1 | P5 |
| 102 | 1/1/03 00:01:00 | | Q2 | P1 |
| 103 | 1/1/03 00:02:00 | | | P2 |
| 104 | 1/1/03 00:02:05 | | | P3 |
| 201 | 1/2/03 00:00:00 | U2 | Q2 | P4 |
| 202 | 1/2/03 00:01:00 | | | P1 |
| 203 | 1/2/03 00:02:00 | | | P4 |
| 204 | 1/2/03 00:04:00 | | Q1 | P2 |
| 205 | 1/2/03 00:04:05 | | | P3 |
| 301 | 1/3/03 00:00:00 | U3 | Q3 | P3 |
| 302 | 1/3/03 00:04:00 | | Q2 | P1 |
| 303 | 1/3/03 02:00:00 | | Q3 | P5 |
| 401 | 1/4/03 00:00:00 | U2 | Q1 | * |
| 402 | 1/4/03 00:06:00 | | Q2 | P4 |

(* = query with no associated pick)

Table 1A illustrates a tabulation of click information contained in Table 1 in accordance with a Q2P correlation. For comparison, Table 1B illustrates a tabulation of the click information contained in Table 1 in accordance with a Q2RP correlation.

TABLE 1A
(Q2P Results)

| | Q1 | Q2 | Q3 |
|---|---|---|---|
| P1 | 2 | 3 | 1 |
| P2 | 1 | 1 | — |
| P3 | 2 | 3 | 1 |
| P4 | 1 | 1 | — |
| P5 | 1 | 2 | 1 |

TABLE 1B
(Q2RP Results of Prior Art)

| | Q1 | Q2 | Q3 |
|---|---|---|---|
| P1 | — | 3 | — |
| P2 | 1 | — | — |
| P3 | 1 | 1 | 1 |
| P4 | — | 2 | — |
| P5 | 1 | — | 1 |

Due to the fact that numerous factors can vary or penalize the scores, we will assume one pick represents a score increment of +1, except for the following penalization situations, where we will assume the pick represents a score increment of 0. Assuming a time threshold, the click in row 103 is penalized in both tabulations due to the user spending a very short time at the URL. Assuming daily database batch updates, the click in row 203 would typically be penalized by the prior art tabulation of Table 1B as a duplicate of click 201. The clicks in rows 203 and 402 are penalized by the tabulation, in accordance with an embodiment of the invention, as duplicates of click 201.

For Query Q1, URL P1, which was never clicked immediately subsequent to Q1, has garnered a high score in the tabulation, in accordance with an embodiment of the invention, because multiple users chose it before or after—though not immediately after—issuing Query Q1. The whole matrix of scores for the tabulation, in accordance with an embodiment of the invention, is richer, as many more associations are noted. Some scores, such as that for Q2P4, are lower, due to the retention of session data indicating that all the clicks came from a single user, permitting the identification of more duplicates.

In practical applications of Q2P, we can retain the distinction as to whether a particular association was Q2RP or non-Q2RP. A single, uncorrelated non-Q2RP click (such as Q3P1 in the table) may not inspire enough confidence to release the result to users, whereas for a single, uncorrelated Q2RP click, the association is reinforced by the fact that the search engine presented the result for the original search.

A pick-to-query (P2Q) correlation associates all queries recorded during a user session that are correlated with a given pick issued during that user session. The search log excerpt of Table 1 illustrates the output of P2Q correlation. That is, the same data generated for Q2P can be re-indexed for P2Q.

Further details of Q2P and P2Q are described in U.S. Pat. No. 7,181,337, which is incorporated herein by reference in its entirety.

A query-to-query (Q2Q) correlation associates all queries issued during a user session with all other queries issued during that session. For one embodiment, a score may be assigned to each association based upon various factors, including the time between queries, the number of intervening queries and/or picks, age or order of the association (relative to older or newer associations), whether or not the query results generated picks, and the pair-wise order of the associated queries, among others.

Determining if the query results generated picks, as well as the pair-wise order of the associated queries, can be particularly informative, as they can indicate whether one query is a correction of another. For any practical application, it is useful to know which of two associated queries is an error, and which is a correction.

A search log excerpt, in accordance with one embodiment of the invention, is shown below as Table 2. Only the query portion of the search log is required to create a Q2Q table:

TABLE 2

| Row | Timestamp | User ID | Query |
|---|---|---|---|
| 101 | 1/1/03 00:00:00 | U1 | Q1 |
| 102 | 1/1/03 00:01:00 | | Q2 |
| 103 | 1/1/03 00:02:00 | | |
| 104 | 1/1/03 00:02:05 | | |
| 201 | 1/2/03 00:00:00 | U2 | Q2 |
| 202 | 1/2/03 00:01:00 | | |
| 203 | 1/2/03 00:02:00 | | |
| 204 | 1/2/03 00:04:00 | | Q1 |
| 205 | 1/2/03 00:04:05 | | |
| 301 | 1/3/03 00:00:00 | U3 | Q3 |
| 302 | 1/3/03 00:04:00 | | Q2 |
| 303 | 1/3/03 02:00:00 | | Q3 |
| 401 | 1/4/03 00:00:00 | U2 | Q1 |
| 402 | 1/4/03 00:06:00 | | Q2 |

Table 2A illustrates a tabulation of the click information contained in Table 2 in accordance with an embodiment of the invention (assuming the order of queries issued is ignored):

TABLE 2A
(Q2Q Results)

| | Q1 | Q2 | Q3 |
|---|---|---|---|
| Q1 | — | 2 | — |
| Q2 | — | — | 1 |
| Q3 | — | — | — |

The lower triangular area of Table 2A can be used to retain the pair-wise query order information, avoiding double-booking cases like rows 301-303.

As noted above, a scoring scheme may be employed in which numerous factors can vary or penalize the score. For example, duplicates (e.g., association in rows 101 and 102 and associations made in rows 401 and 402) could be penalized. Or, for example, an uncorrelated Q2Q association, like Q2Q3 would not inspire enough confidence to release the result to users.

Referring back to FIG. 3, the classifier 316 receives concepts from the extractor 308. The classifier 316 is configured to determine a category or set of categories associated with text. The classifier 316 may include a category hierarchy. The category hierarchy is a predefined hierarchy of categories and information. The classifier 316 uses the category of the text to determine the important parts of the textual input 328. The important parts of the textual input 328, as determined by the classifier 316, are used to identify the important concepts of the textual input 328. For example, if the search query is “diabetes side-effects in ten year olds,” the classifier 316 analyzes each of the N-grams received from the extractor 308 and determines that this query is related to previously submitted queries: diabetes, diabetes side-effects and diabetes ten year olds. The classifier may also identify the category (e.g., health, health-children) for each of the previously submitted queries. This information (previously submitted queries and, optionally, category) is communicated to the extractor 308. The classifier 316 also communicates the categories to the computational unit 320.

The classifier 316 may include a learning phase in which for each category, editors collect a large number of related documents and store the documents in a repository. The classifier reads the related documents and learns to recognize their important features. Important features may, for example, be identified when a particular word appears in a large percentage of the documents for a particular category. Exemplary categories include news, sports, entertainment, art, history, finance, etc.

The computational unit 320 receives information from the database 312 and the classifier 316. In particular, the computational unit 320 receives the classification and, optionally, the score from the database 312, and the category from the classifier 316. The computational unit 320 determines the category of the textual input 328, as a whole, based on the information from the database 312 and the classifier 316.

For example, the computational unit 320 may receive information from the classifier 316 that the query of “diabetes side-effects in ten year olds” is in the categories: health, nutrition, children, etc. The computational unit 320 may also receive information from the database 216 that the query of “diabetes side-effects in ten year olds” is in the classification of health-diabetes, health-side-effects health-nutrition, health-children, children-health, children-diabetes, etc. The computational unit 320 may then determine that the query “diabetes side-effects in ten year olds” is most likely to be in the category of health-children or children-diabetes.

In one embodiment, the computational unit 320 determines a set of categories to assign the textual input 328. The computational unit 320 may also assign a score to each category in the set of categories assigned to the textual input 328. That is, the computational unit 320 determines the relative importance of each category assigned to the textual input 328. For example, the computational unit 320 may identify the categories of the search query “diabetes side-effects in ten year olds” as health—80%; children—20%. In another example, the computational unit 320 may identify a search query for “apple” as being in the categories of computers—95% and fruit—5%. In another example, the computational unit 320 may identify the search query “Apache” as being computers—95% and history—5%.

The computational unit 320 transmits the determination of category or categories and, optionally, scores to the output interface 324.

The computational unit 320 may include a statistical tool. The statistical tool is used to extract the most likely category among categories utilizing interpolation of categories. For example, the statistical tool may classify the itunes website (http://www.apple.com/itunes/) as follows:

TABLE 3

| Query | Classification |
|---|---|
| ipod nano | Consumer_Electronics # 86% >> MP3_Players # 89% |
| itunes | Consumer_Electronics # 0% >> MP3_Players # 0% |
| itunes music | Consumer_Electronics # 53% >> MP3_Players # 62% |
| store | |
| apple itunes | Consumer_Electronics # 68% >> MP3_Players # 93% |
| download | Consumer_Electronics # 20% >> MP3_Players # 18% |
| itunes | |
| itunes help | Consumer_Electronics # 19% >> MP3_Players # 66% |
| apple itunes | Consumer_Electronics # 62% >> MP3_Players # 90% |
| burn cds off | Computers # 14% >> Software # 9% |
| internet for | |
| free | |
| free downloads | Computers # 22% >> Software # 8% |
| itunes | |
| what is itunes | Consumer_Electronics # 0% >> MP3_Players # 0% |
| itunes store | Consumer_Electronics # 46% >> MP3_Players # 49% |
| what are itunes | Consumer_Electronics # 0% >> MP3_Players # 0% |

The computational unit 320 has thus classified each one of the correlated queries according to a degree of confidence. The computational unit 320 then proceeds to determine the most relevant category or categories among the categories in Table 3. In the present example, the most relevant categories are as follows:

Level 1: Consumer_Electronics (3.54), Computers (0.36);

Level 2: Consumer_Electronics/MP3_Players (2.67), Computers/Software (0.03).

The computational unit 320 also matches search requests with a respective category utilizing the features identified for each category. The computational unit 320 is used to extract the most likely category among all the categories utilizing a stochastic method.

The output interface 324 receives the determination from the computational unit 320. The output interface 324 transmits the determination to the server or search engine. It will be appreciated that the computational unit could transmit the determination directly.

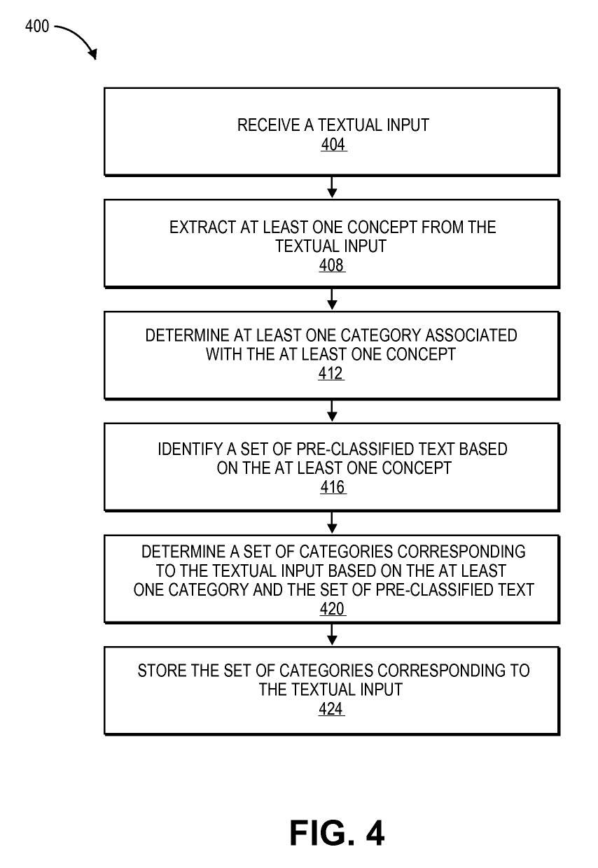

FIG. 4 is a flow diagram of a method of approximating an input classification 400. The method 400 is performed by the system of FIG. 3. It will be appreciated however that any computer system may perform the method of FIG. 4.

The method 400 begins at block 404 by receiving a textual input. The textual input may be, for example, a search query, a snippet of a web page, a description of an image, a blog post, a news article, an image, a sound, a video, a podcast, any digital image or multimedia object, and the like. If the input is a sound or includes audio, the audio aspect of the audio aspect of the input is converted into text using techniques known to those of skill in the art.

The method 400 continues at block 408 by extracting at least one concept from the textual input. The at least one concept includes N-grams of the input and may include only the most important concepts (e.g., N-grams) from the textual input.

The method 400 continues at block 412 by determining at least one category associated with the at least one concept. The category may be used to determine the category of the textual input and/or to identify the most important N-grams or concepts of the textual input.

The method 400 continues at block 416 by identifying a set of pre-classified text based on the at least one concept. In one embodiment, a database is searched to determine whether the concept(s) match any previously submitted queries.

The method 400 continues at block 420 by determining a set of categories corresponding to the textual input based on the at least one category and the set of pre-classified text. Various statistical or other interpolative methods may be used to analyze the classification and categories of the concepts to determine the category or set of categories of the textual input.

The method 400 continues at block 424 by storing the set of categories corresponding to the textual input.

In one embodiment, the method 400 may continue by generating search results in response to search queries when the textual input is a search query. The search results include a plurality of URLs. The most relevant category for the query is used to provide URLs that are primarily in the same category as the query.

In one embodiment, the method 400 continues by adjusting the ranking formula for the search results of a search query. For example, the freshness of results for finance and sports may be boosted for search queries in the finance or sports categories, while the authority of pages for history and arts is considered when ranking the results for search queries in the history or arts categories.

In another embodiment, the method 400 includes returning greater or fewer results from certain categories of search results based on the classification of the query. For example, the number of results in each category may be based on the score assigned to the category.

In another embodiment, the method 400 continues by hiding or showing more related search queries based on the category of the search query.

In one embodiment, the method 400 continues by dividing web pages into homogeneous groups if the input content is a web page or snippet of a web page. For example, downloaded web pages can be stored in separate categories, even separate partitions. By storing the web pages in separate categories, retrieval speed can be increased. Similarly, the method 400 can be used to identify spam web pages or pages having adult content when the input is the content of a web page or a snippet of a web page.

In another embodiment, the method 400 includes extracting an advertisement or advertisements from a plurality of advertisements utilizing the category.

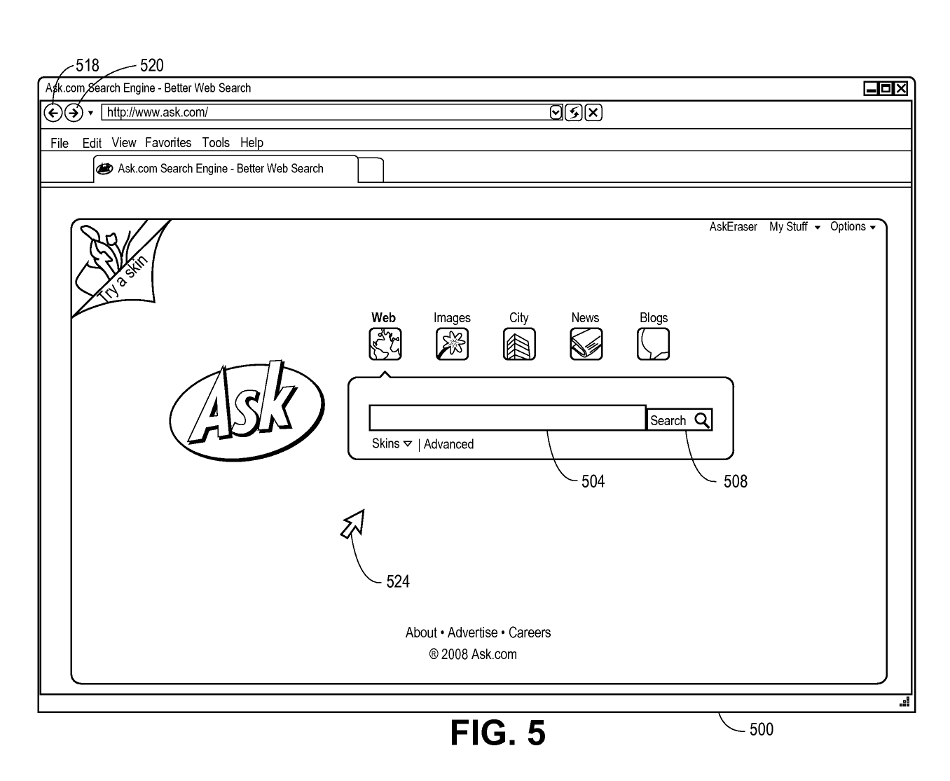

FIG. 5 illustrates an exemplary user interface 500. The illustrated user interface 500 includes a user input box 504 and a button 508. The user input box 504 is configured to receive textual user input. The button 508 is designated by “Search” in FIG. 5 and is configured to be selectable by the user. A user accesses the interface 500 to enter a search query in the user input box 504. The user presses the “enter” key on a keyboard or selects (e.g., mouse clicks, mouses over, etc.) the button 508. Selection of the button 508 or pressing the “enter” key on a keyboard in a communication of the text entered in the input box 504 from the client system 18 to the search engine 14 and the search system 12.

The user can access the user interface 500, by opening an Internet browser application, such as Microsoft's Internet Explorer, and entering www.ask.com into the site address box 516. The user can navigate between pages on the website using back and forward buttons, 518, 520, as well. A cursor 524 can be used with a mouse or touchpad to navigate the cursor around the web page.

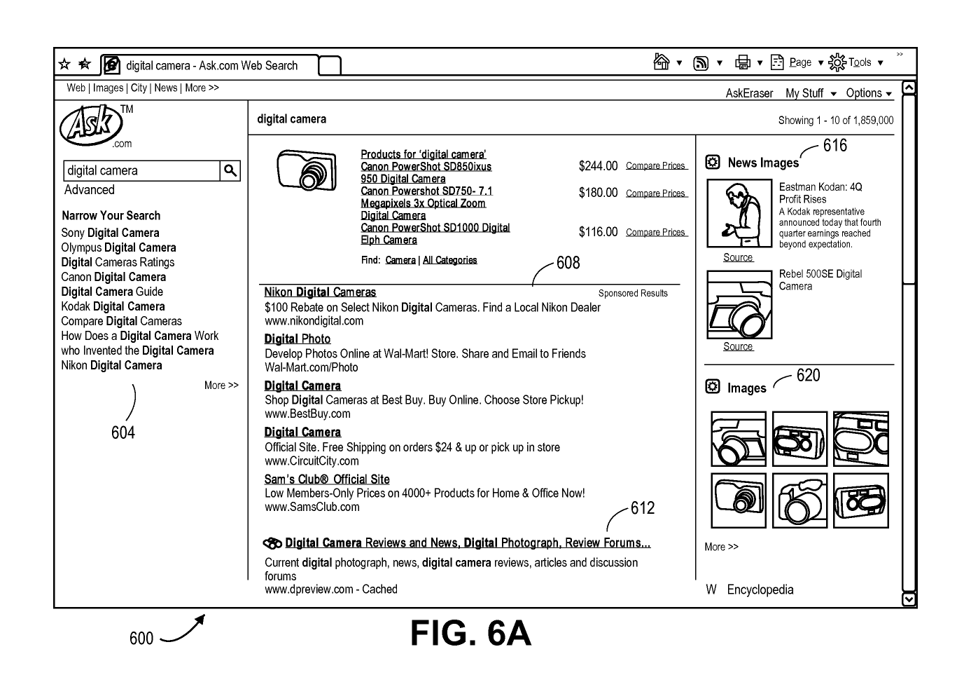

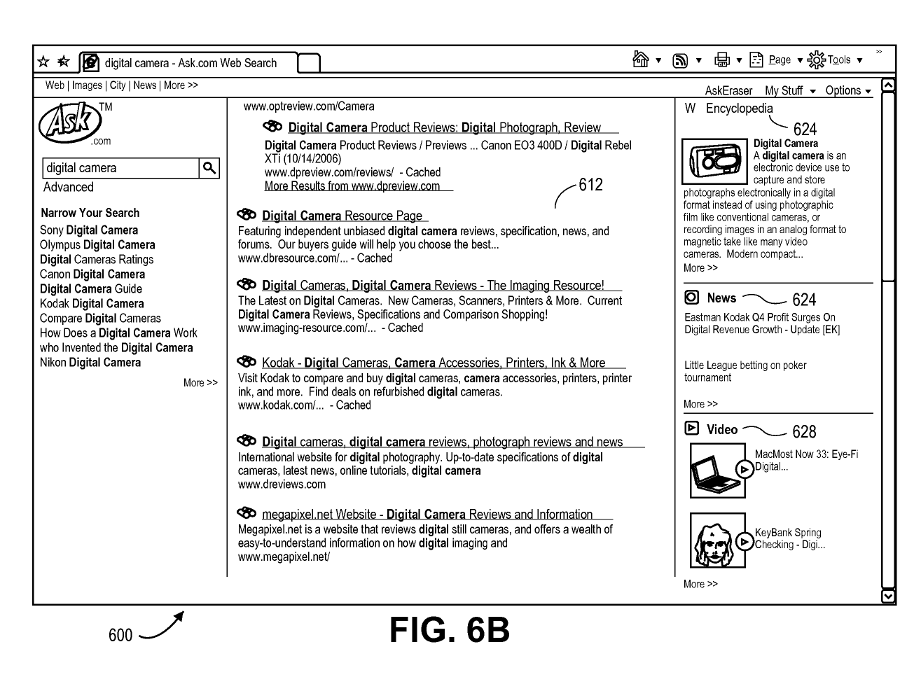

FIGS. 6A and 6B illustrate an exemplary search results page 600. FIGS. 6A and 6B together form the same results page 600, but views of the page from different scrolling points. It will be appreciated that the results pages of FIGS. 6A and 6B would typically appear as a single page on the user's web application.

The illustrated search results page 600 includes several regions including a suggested search term region 604, an advertisements region 606, a sponsored results region 608, a web results region 612, a news images region 616, an images region 620, an encyclopedia region 624, a news region 626 and a video region 628. It will be appreciated that the information presented is not limited to the above categories and may include a fewer number or greater number of categories. In addition, the amount of information in each category may vary from that illustrated. As described above, the above regions may vary based on the category determined with the method of FIG. 4.

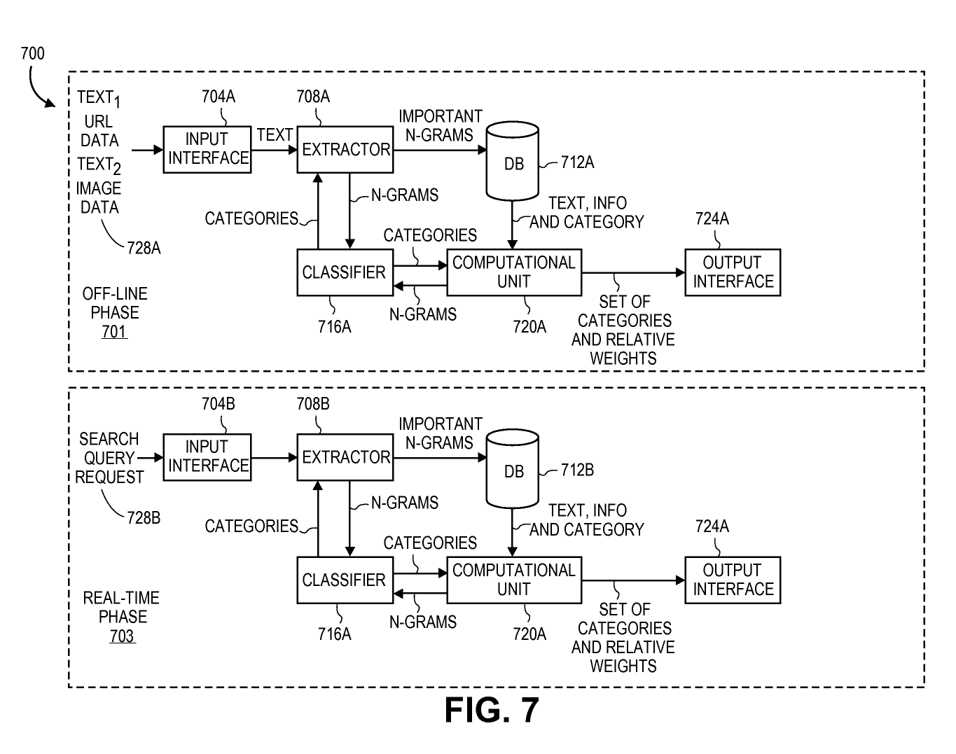

FIG. 7 illustrates an off-line phase 701 and a real time phase 703 of an input approximation classification system 700. The off-line phase 701 includes an input interface 704a, an extractor 708a, a database 712a, a classifier 716a, a computational unit 720a and an output interface 724a that operate as described above with reference to FIG. 3. Similarly, the real time phase 703 includes an input interface 704b, an extractor 708b, a database 712b, a classifier 716b, a computational unit 720b and an output interface 724b that operate as described above with reference to FIG. 3.

The off-line phase 701 is configured to identify off-line text, such as text from a web page or test associated with an image. In one embodiment, the classification of the text of the off-line phase 701 is used to associate the text with a particular category.

The real-time phase 703 is configured to identify text such as a search query received at a search engine. In one embodiment, the classification of the search query in the real-time phase 703 is used to provide search results in response to the search query based on the category or categories identified by the real-time phase 703 of the input approximation classification system 700.

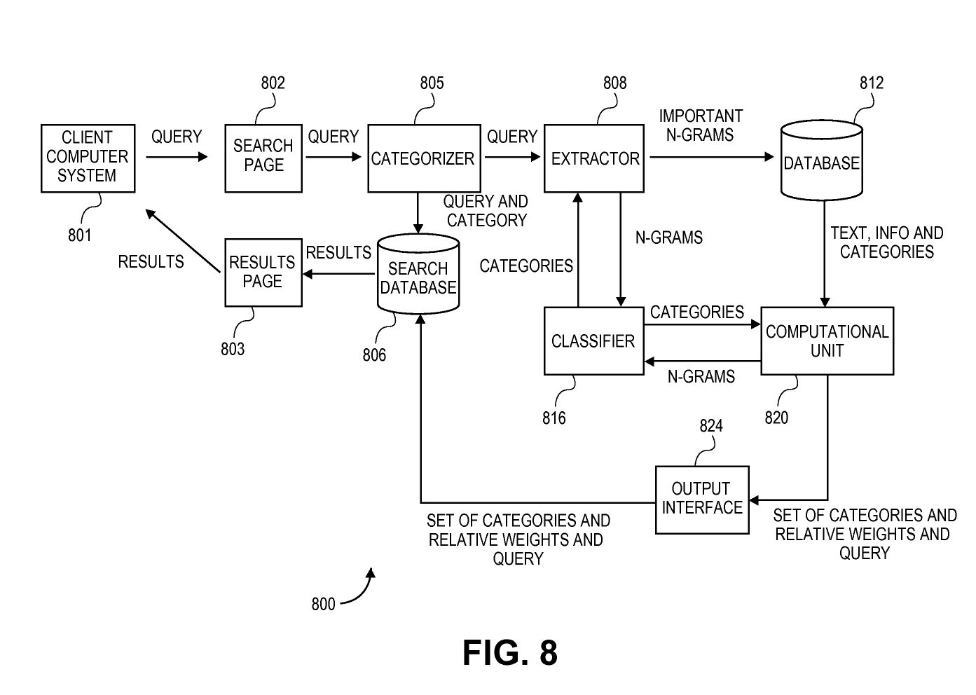

FIG. 8 illustrates an input classification system 800 including an input approximation classification system 804. The classification system 800 receives text, such as a search query from a client computer system 801 through a search page 802, such as the search page shown in FIG. 5. A results page 803, such as the results page shown in FIGS. 6A and 6B, is provided in response to the search query with search results to the client computer system 801.

The query is received at a categorizer 805. If the query is recognized as a query that has been previously submitted to the categorizer, the categorizer 805 uses the search request to extract a plurality of related queries using Q2Q. The categorizer 805 then matches the search request and each one of the related queries with a respective category utilizing the features identified for each category. A statistical tool is used to extract the most likely category among all the categories utilizing a stochastic method. The categorizer 805 thus matches the search request with a category among a plurality of categories. Search results are generated using the search database 806. The search results include a plurality of URLs. In one embodiment, the most relevant category for the query is used to provide URLs that are primarily in the same query.

If the categorizer 805 does not recognize the query, the query is transmitted to the extractor 808. The extractor 808, database 812, classifier 816, computational unit 820 and output interface 824 operate as described above with reference to FIG. 3 to identify a category or set of categories associated with the search query.

The output interface 824 transmits the category or set of categories associated with the search query to the search database 806, which provides results in response to the search query in the form of a results page 803 to the client computer system 801.

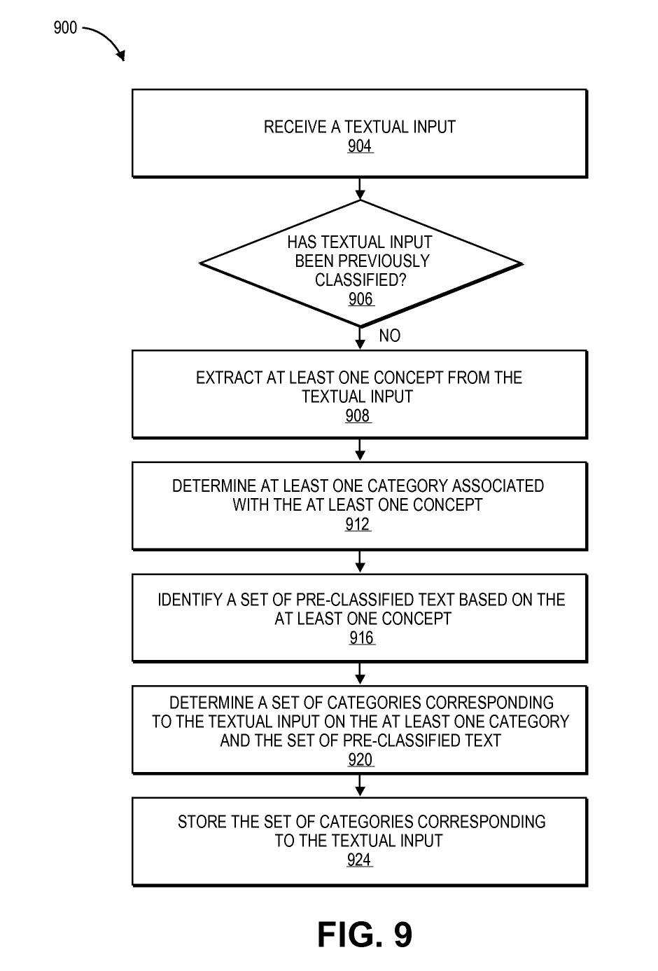

FIG. 9 illustrates a method of classifying an input 900 including an input approximation classification method. The method 900 begins at block 904 by receiving a textual input. The method 900 continues by determining whether the textual input has been previously classified (block 906). If yes, the category of the query is determined based on the previous determination. If no, the method 900 continues to block 908 by extracting at least one concept from the textual input. The method 900 continues at block 912 by determining at least one category associated with the at least one concept. The method 900 continues at block 916 by identifying a set of pre-classified text based on the at least one concept. The method 900 continues at block 920 by determining a set of categories corresponding to the textual input based on the at least one category and the set of pre-classified text. The method 900 continues at block 924 by storing the set of categories corresponding to the textual input.

Embodiments of the invention are advantageous in identifying what a user is looking for when the user enters a search query. In particular, embodiments of the invention are advantageous in identifying a query when there are not enough users in the system to make a correlation of the prior art systems and methods. That is, embodiments of the invention are advantageous for queries for which there is no existing data.

The foregoing description with attached drawings is only illustrative of possible embodiments of the described method and should only be construed as such. Other persons of ordinary skill in the art will realize that many other specific embodiments are possible that fall within the scope and spirit of the present idea. The scope of the invention is indicated by the following claims rather than by the foregoing description. Any and all modifications which come within the meaning and range of equivalency of the following claims are to be considered within their scope.

1. A computer-implemented method comprising:
receiving a textual input;
extracting at least one concept from the textual input;
determining at least one category associated with the at least one concept;
identifying a set of pre-classified text based on the at least one concept;
determining a set of categories corresponding to the textual input based on the at least one category and the set of pre-classified text; and
storing the set of categories corresponding to the textual input.

2. The computer implemented method of claim 1, further comprising determining an answer to the textual input based on the set of categories.

3. The computer implemented method of claim 1, wherein the textual input comprises a textual search query.

4. The computer implemented method of claim 1, wherein the textual input comprises textual information from a web page.

5. The computer implemented method of claim 1, wherein the textual input comprises textual information associated with an image.

6. The computer implemented method of claim 1, wherein the concept comprises a name.

7. The computer implemented method of claim 1, wherein the concept comprises a word.

8. The computer implemented method of claim 1, wherein the concept comprises a N-gram.

9. The computer implemented method of claim 1, wherein identifying a set of pre-classified text based on the at least one concept further comprises identifying a relative importance of each pre-classified text in the set of pre-classified text.

10. The computer implemented method of claim 9, wherein identifying the relative importance of each pre-classified text in the set of pre-classified text comprises assigning a score to each pre-classified text.

11. The computer implemented method of claim 1, wherein determining at least one category associated with the at least one concept further comprises determining a set of categories associated with the at least one concept.

12. The computer implemented method of claim 1, wherein determining a set of categories to assign the input based on the at least one category and the set of preclassified text further comprises assigning a score to each category of the set of categories.

13. The computer implemented method of claim 2, wherein determining the answer comprises determining a set of URLs and providing the set of URLs to a user.

14. The computer implemented method of claim 2, wherein determining the answer comprises determining a set of URLs, and wherein determining the set of URLs comprises identifying URLs from each category from the set of categories.

15. The computer implemented method of claim 2, wherein determining the answer comprises determining an advertisement to provide to a user.

16. The computer implemented method of claim 2, wherein determining the answer comprises determining a set of search queries and transmitting the set of search queries to a user.

17. The computer implemented method of claim 16, further comprising receiving a selection of a search query from the set of search queries and transmitting a set of URLs associated with the selection to the user.

18. The computer implemented method of claim 2, wherein determining the answer comprises identifying one or more of an image, video, blog, news information, news image, web page, sound, podcast, digital object or multimedia object.

19. The computer implemented method of claim 13, displaying the set of URLs on a client computer, the set of URLs organized according to each category in the set of categories.

20. The computer implemented method of claim 2, wherein determining the answer comprises identifying a web page as a spam page.

21. The computer implemented method of claim 2, wherein determining the answer comprises identifying a web page as having adult content.

22. The computer implemented method of claim 1, extracting at least one concept from the textual input comprises extracting a plurality of concepts from the textual input.

23. The computer implemented method of claim 22, wherein:
determining at least one category associated with the at least one concept comprises determining at least one category associated with each concept of the plurality of concepts; and
identifying a set of pre-classified text based on the at least one concept comprises identifying a set of pre-classified text based on each concept of the plurality of concepts.

24. A computer system comprising:
an input interface to receive a textual input;
an extractor to extract at least one concept from the textual input;
a database having a plurality of concepts stored therein, each concept associated with at least one classification;
a classifier to associate the at least one concept with at least one category;
a computational unit to determine a category of the textual input based on the at least one classification of the at least one concept from the database and the at least one category of the at least one concept from the classifier; and
an output interface to transmit the category of the at least one concept in response to the textual input.

25. A computer-readable storage medium having stored thereon a set of instructions which, when executed by a processor of a computer, executes the method comprising:
receiving a textual input;
extracting at least one concept from the textual input;
determining at least one category associated with the at least one concept;
identifying a set of pre-classified text based on the at least one concept;
determining a set of categories corresponding to the textual input based on the at least one category and the set of pre-classified text; and
storing the set of categories corresponding to the textual input.
